(19) United States
(12) Patent Application Publication
(10) Pub. No.: US 2008/0099074 A1
(43) Pub. Date: May 1, 2008

(54) IRRIGATION SYSTEM WITH INFLATABLE SUCTION HOSE

(76) Inventor: Burt J. Peterson, Waterford, WI (US)

Correspondence Address: BOYLE FREDRICKSON S.C., 840 North Plankinton Avenue, MILWAUKEE, WI, 53203, US

(21) Appl. No.: 11/968,505

(22) Filed: Jan. 2, 2008

Related U.S. Application Data
(63) Continuation-in-part of application No. 11/501,444, filed on Aug. 9, 2006, now Pat. No. 7,325,576.
(60) Provisional application No. 60/706,528, filed on Aug. 9, 2005.

(51) Int. Cl. F16L 11/00; F17D 1/08

(52) U.S. Cl. 137/236.1; 138/115

(57) ABSTRACT

A water pumping system for irrigation or the like uses a suction pump attached to a suction hose that has supporting ribs that may be inflated to hold the hose open against suction for use and deflated to allow the suction hose to be folded or collapsed for storage and transportation.

### RELATED CASES

This application is a continuation in part on U.S. application Ser. No. 11/501,444 filed Aug. 9, 2006 hereby incorporated by reference in which claims the benefit of U.S. Provisional Application 60/706,528 filed Aug. 9, 2005, hereby incorporated by reference.

### BACKGROUND OF THE INVENTION

Pumping water from a non-pressurized source, such as a stream, river, or pond may be necessary for irrigation or an emergency situation for the provision of water. While submersible pumps can be used in some instances, more typically a stationary gasoline powered pump is used which must be positioned on the land away from the body of water. Non-collapsible suction hose must be used to draw water from the source to the pump.

Because this hose is non-collapsible, it is difficult to store or transport a significant length of this hose. Particularly in emergency situations or situations where mobility is required, for example irrigation, the provision of non-collapsible hose suitable for suction use can be a significant impediment.

### SUMMARY OF THE INVENTION

The present invention provides for a collapsible suction hose that may be carried in a folded state and then inflated for use on site. Inflated ribs, which may be filled with water or air on site, prevent the hose from collapsing under the negative pressure necessary to draw water into the hose by a pump or the like.

Specifically, the present invention provides a method of pumping water from a surface of a body of water in which a portable suction pump is placed adjacent to the body of water and a collapsible suction pipe is attached to the suction pump, the collapsible pipe providing a water resistant tubular body extending from the suction pump to the body of water, the conduit flexibly opening to provide a channel for passage of liquid water and collapsing for storage. At least one stiffening rib attached to the tubular body is inflated to hold the conduit open as water is pulled by suction of the suction pump.

It is thus one object of the invention to provide a highly portable water pumping system suitable for irrigation or emergency use.

The stiffening rib may be deflated and the tubular body flattened in a direction perpendicular to its length to roll the suction pipe about an axis.

It is thus an object of the invention to allow compaction of normally bulky suction pipes for improved mobility and storage.

The stiffening rib may be inflated with water from the body of water.

It is thus an object of the invention to eliminate the need to store or transport an inflation fluid.

An end of the stiffening rib may be placed in the body of water and water drawn through the stiffening rib may be used in its inflation.

It is thus another object of the invention to allow the stiffening rib to perform double duty both for initial suction of water to the suction pump necessary for installation of the stiffening rib and for stiffening support of the tubular conduit.

The end of the stiffening rib that may be placed in the body of water may include a check valve so that water may be drawn through the stiffening rib in a first direction and then reversed in flow of water to inflate the stiffening rib.

It is thus an object of the invention to allow dual use of the stiffening rib without access to the stiffening rib after it has been placed in the body of water.

The inflation of the stiffening rib may extend the conduit.

It is thus an object of the invention to permit rapid extension of the flexible conduit.

The suction pipe may be assembled from multiple collapsible suction pipe sections using couplings that join tubular bodies of the sections and the inflatable stiffening rib of the section.

It is thus an object of the invention to permit arbitrary length of suction pipe to be created when different distances of water transport must be provided.

These particular objects and advantages may apply to only some embodiments falling within the claims and thus do not define the scope of the invention.

### BRIEF DESCRIPTION OF THE DRAWINGS

FIG. 1 is a perspective view of a pumping station showing use of the suction hose of the present invention near a natural body of water;

FIG. 2 is a cross-section of the suction hose of FIG. 1 when in the open configuration, showing inflation of ribs providing annular sectors to surround a conduit of the suction hose;

FIG. 3 is a figure similar to that of FIG. 2, showing the suction hose of FIG. 2 in the collapsed configuration;

FIG. 4 is figure similar to that of FIG. 2, showing an alternative embodiment of the ribs using multiple tubes to create the stiffening structure;

FIG. 5 is a side-elevational view of one end of the suction hose of the present invention, also showing a dual, crossing-helix configuration that provides both extension and radial support of the conduit;

FIG. 6 is a figure similar to that of FIG. 5, showing the embodiment of FIG. 4 with two suction hoses connected by a coupling and the inflatable ribs connected by an ancillary coupling;

FIG. 7 is an elevational cross-section of an alternative embodiment of the invention, having an internal supporting spring wherein the stiffening ribs serve to extend the suction hose;

FIG. 8 is a figure similar to that of FIG. 7 showing the suction hose of FIG. 7 when inflated and fully extended;

FIG. 9 is an elevational cross-section of a coupling between two suction tubes, showing the connection both of the central conduit and the stiffening ribs by means of the coupling interface;

FIG. 10 is a cross-sectional elevational view of a vent valve that prevents suction from being drawn until the ribs are properly inflated, such as may be incorporated into the couplings or a separate structure;

FIG. 11 is figure similar to that of FIG. 2, showing an alternative embodiment of the ribs using one or more helically or annularly wound tubes to create the stiffening structure;

FIG. 12 is a figure similar to that of FIG. 1 showing use of the invention for irrigation or other similar purpose using a stationary land-based suction pump; and

FIG. 13 is a schematic representation of the valving system used with the suction pump of FIG. 12 for inflating the stiffening rib from the surface body of water.

### DETAILED DESCRIPTION OF THE PREFERRED EMBODIMENT

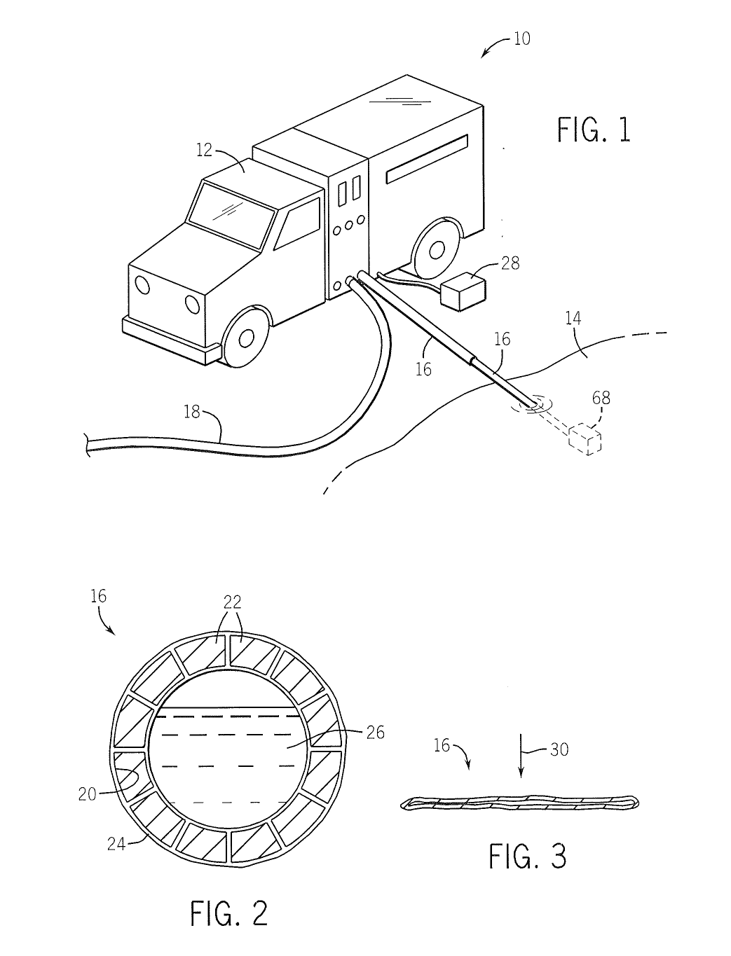

Referring now to FIG. 1, a pumping truck 10 may carry a pumping station 12 connected to the engine of the truck to provide for pumping of water as is understood in the art.

When a normal source of pressurized water from a hydrant or the like is not available, the truck 10 may be placed near an unpressurized source of water 14, such as a lake or river, and one or more suction hoses 16 connected to the pumping station 12 may draw water 14 from the lake or river into a tank in the truck 10 and/or out through a separate hose 18 for use on a fire.

Referring now to FIG. 2, in one embodiment of the present invention, the suction hose 16 employs a central flexible conduit 20, such as a plastic bonded fabric or extruded synthetic rubber, providing a water impermeable barrier. The conduit 20 is surrounded by multiple ribs 22, each forming an adjacent parallel passageway extending along the length of the suction hose 16, and each having a cross-section of a contiguous sector of an annulus surrounding the conduit 20. The ribs 22 may share material with the conduit 20 so that the conduit wall is all or in part formed by a wall of the ribs 22. The ribs 22 may be sheathed in a protective sleeve 24 and are also constructed of a flexible water-impermeable material so that each rib 22 may be inflated either with air or with water to provide a semi-rigid shell, surrounding and supporting the conduit 20 against collapse caused by external air pressure and the low-pressure suction within conduit 20. Pressure within the ribs 22 provide for an effective continuous arch surrounding the conduit 20 that prevents its collapse.

In the open configuration shown in FIG. 2, the conduit 20 may be used to draw a liquid, such as water 26, by suction through the conduit with the inflated ribs 22 supporting the conduit 20 against collapse from air pressure. An opening of 2 inches in diameter or more and as much as 6 inches in diameter may thereby be provided.

The ribs 22 are air-tight and water-tight collectively, but may have small orifices between the ribs to allow for pressure equalization so that the inflation of a single rib may inflate all ribs.

As shown in FIG. 1, an air compressor 28 may be used to inflate the ribs 22 with air or by means of an intervening water tank (not shown) with water or other liquid. Alternatively, the pumping station 12 may be enlisted for this purpose.

Referring now to FIG. 3, before use of the suction hose 16 and after use of the suction hose 16, the suction hose 16 may be collapsed by compressing it along an axis 30, perpendicular to its length, with the conduit 20 collapsing on itself and the ribs 22 also flattening. In this configuration, the suction hose may be rolled like a conventional fire hose for storage and transportation.

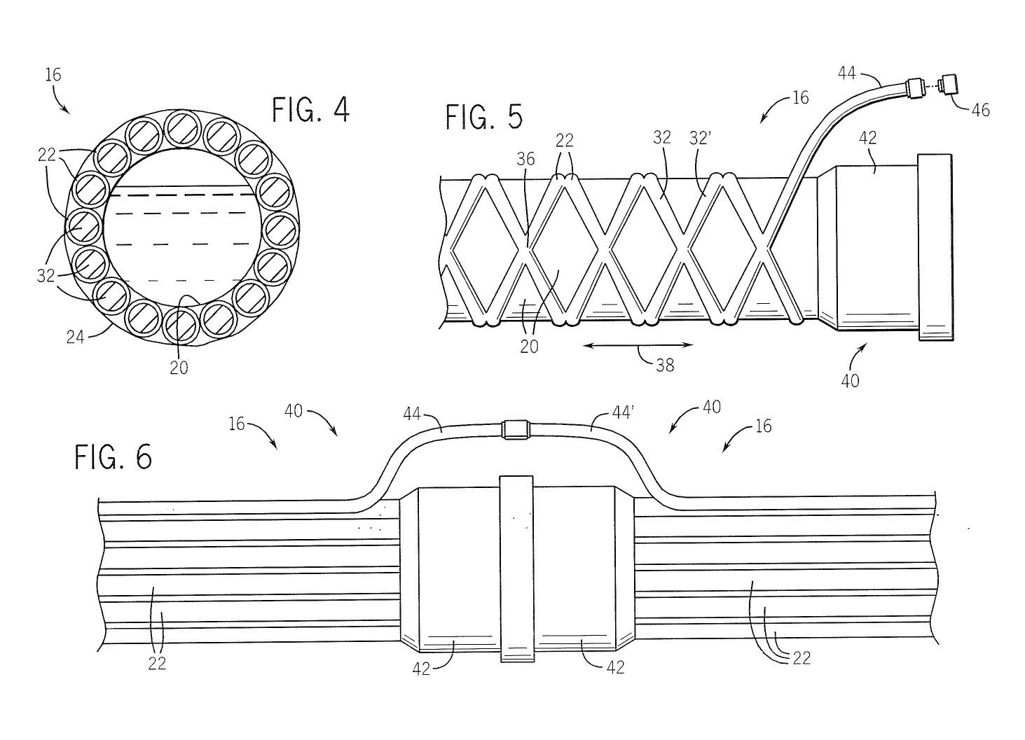

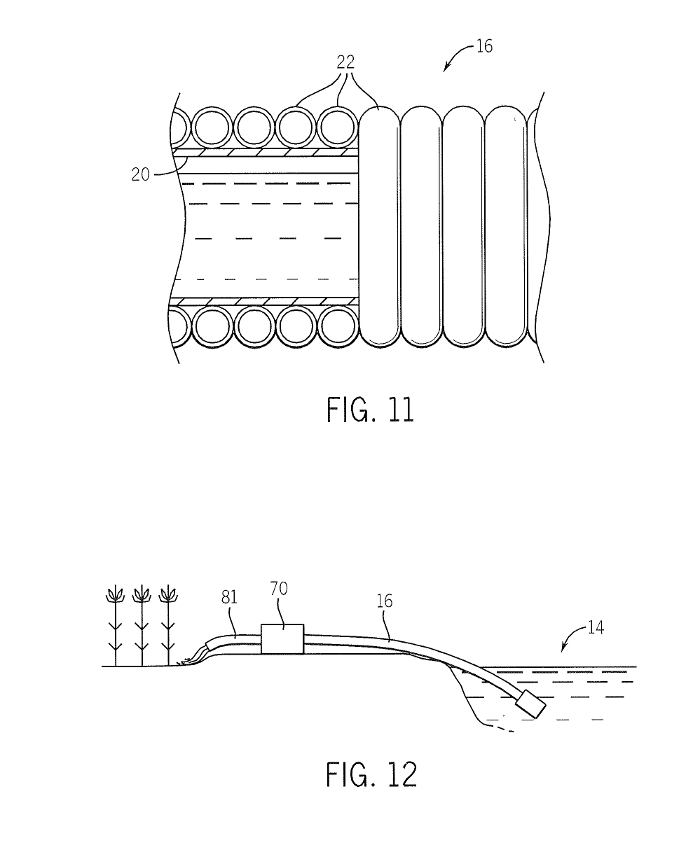

Referring now to FIG. 4, in an alternative embodiment, the ribs 22 may be tubes 32 attached to the wall of the conduit 20 on its outside or inside and extending along its length to provide a similar stiffening function. The tubes 32 may be aligned parallel to the axis of the length of the suction hose 16 or may pass helically around the suction hose 16. In the limiting case, as shown in FIG. 11, the helical tubes may become adjacent rings communicating with each other through small holds in their sidewalls to provide a flexible bellows-like shell.

Again the tubes 32 and conduit 20 are constructed of a flexible impermeable material that may collapse in a manner similar to that shown in FIG. 3 when the hose is not in use.

Referring now to FIG. 5, in yet another embodiment, the ribs 22 may be tubes 32 and 32′ passing helically about the conduit 20 in opposite directions to join at cross-points 36 to provide an open network surrounding the conduit 20 that both extends the conduit 20 radially and axially along the length 38 of the suction hose 16 when inflated to provide two directions of collapse of the suction hose 16: radially and longitudinally.

As shown in FIG. 5, ends 40 of the suction hose 16 of each of the embodiments may include standard hose couplings 42, having quick-connect or threaded engagements to allow multiple hoses 16 to be connected end-to-end to form longer continuous conduits. The ribs 22 may join with an inflation tube 44 at the ends 40 which may be connected to a corresponding inflation tube 44′ of other suction hoses 16 as shown in FIG. 6. The end of the interconnected suction hoses 16 such as will be immersed in the unpressurized water source, may have its inflation tube 44 plugged by plug 46.

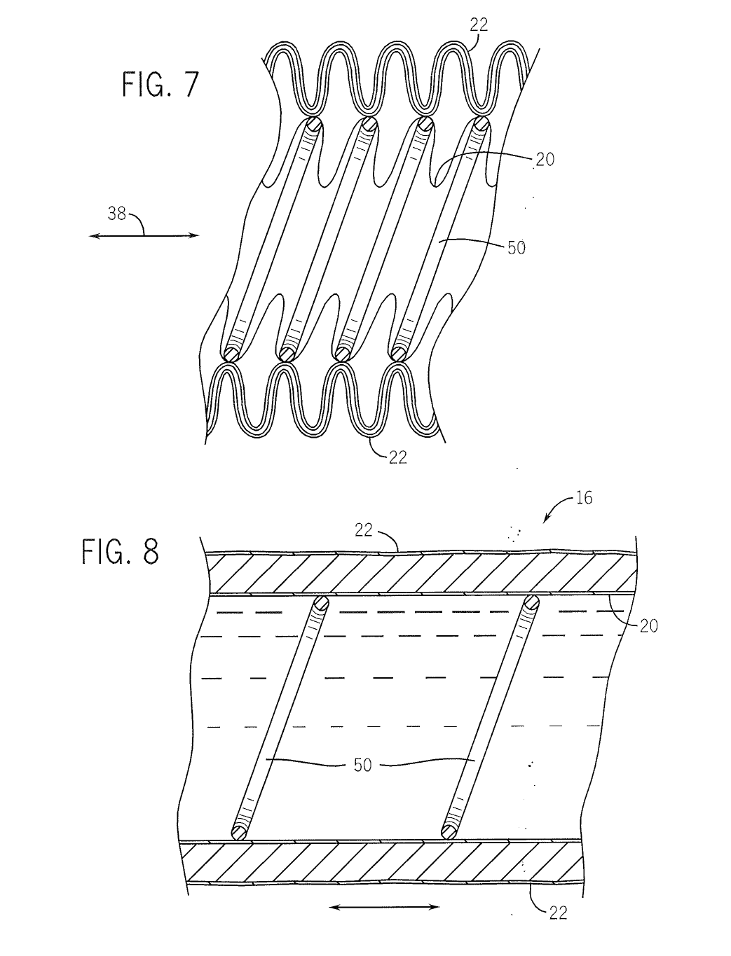

Referring now to FIG. 7, in an alternative embodiment, the conduit 20 may be supported by a stiffening spring 50, constructed, for example, of a flexible metal wire so that the conduit 20 is supported radially but may collapse axially along its length 38. The stiffening ribs 22, in this case, attach at separated points along the length of the conduit 20, and during collapse, fold into an accordion shape. As shown in FIG. 8, when the ribs 22 are inflated, they stiffen axially, extending the conduit 20 axially and separating the coils of the spring 50 to open the suction hose 16 by stretching it along its length.

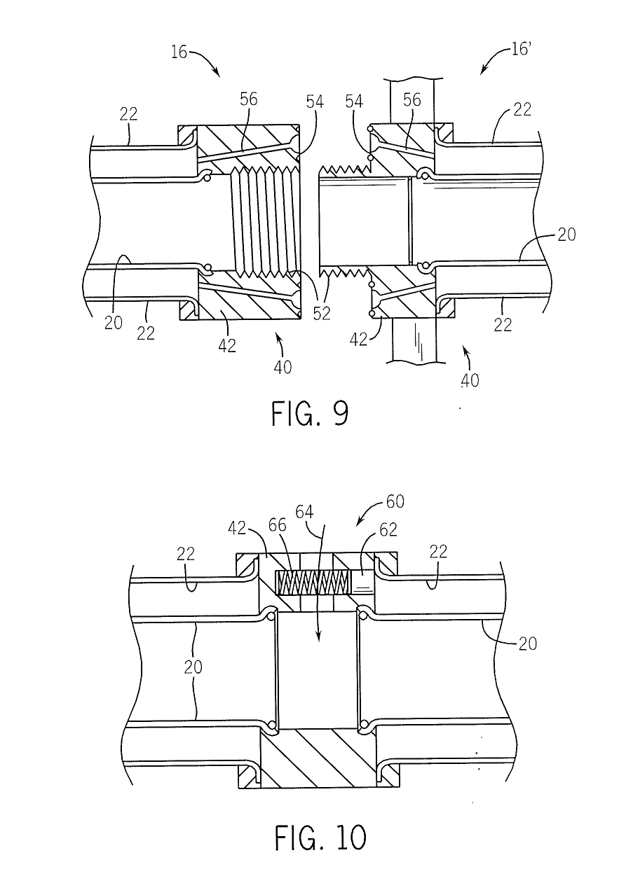

Referring now to FIG. 9, the couplings 42 may provide for interengaging threaded portions 52 that provide for a water-tight joining of the conduits 20 of two hoses 16 and 16′. Coaxially flanges 54 extending radially about the threaded portions 52 may provide for abutting surfaces when the couplings 42 are joined, such as allow joining of ports 56 within the flanges 54 that provide for a continuous passageway between at least one of the ribs 22 in a first suction hose 16 and its corresponding rib 22 in suction hose 16′. The ribs 22 may then distribute the water among them through openings between the ribs 22. In this way, suction hose 16 may be readily joined without the need to assemble inflation tubes 44.

Referring again to FIG. 1, the passageways provided by the ribs 22 may also be used to transport water or compressed air. For example, to power an induction system 68 or pump at the far end of the hoses 16.

Referring now to FIG. 10, a relief valve 60 may be constructed in the flanges 54 or elsewhere along the length of the suction hose 16, providing for a spring piston 62 communicating on one side with an interior of a rib 22 and urged toward the rib 22 and away from a passageway 64 leading between the outside air to the center of the conduit 20 by a spring 66. When there is no pressure in the rib 22, the spring 66 holds the passageway 64 open while when there is pressure in the rib 22, that pressure moves the piston 62 to block the passageway 64 against a spring 66, thus allowing suction to build within the conduits 20.

Referring now to FIG. 12, the hose 16 of the present invention may also be used in an irrigation system or the like where a stationary pump 70, for example, using an air-breathing internal combustion engine and suitable for portable use, may be attached to one end of the hose 16 whose other end may be placed in a natural body of surface water 14 such as a lake, pond, river, canal or stream. Water drawn through the hose 16 is received by the suction pump 70 and discharged through an exit pipe 81 at a higher point.

The hose 16 may be unrolled by pressurizing the ribs 22 from a separate pressure source such as a tank of pressurized air or pressurized water.

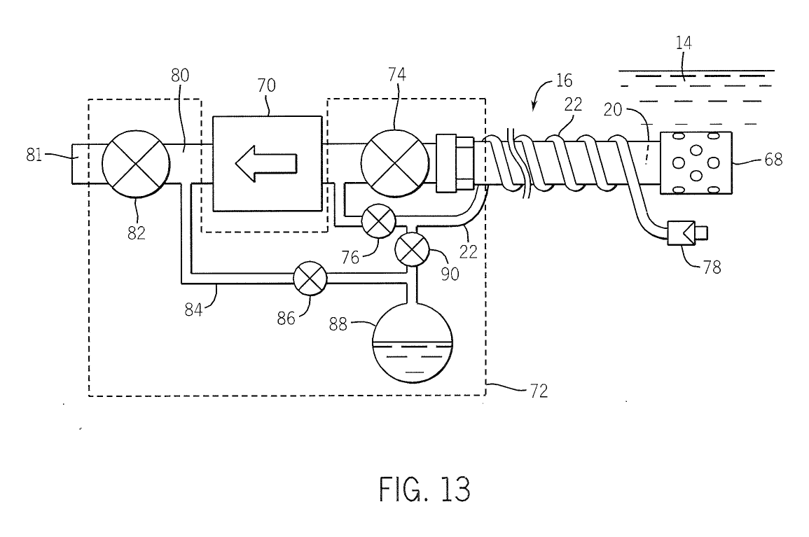

Referring to FIG. 13, in one embodiment, the hose 16 is placed in an extended but collapsed state with one end in the water 14 after the other end has been has been connected to a valve manifold 72 associated with the suction pump 70.

Initially a main valve 74 communicating between the suction pump 70 and the conduit 20 of the hose 16 is closed and a rib valve 76 communicating between the rib 22 and the suction pump 70 is open so that water may be drawn through the rib 22 from the source of water 14. In this embodiment unlike some of the previous embodiments, the rib itself is not collapsible but can withstand a small degree of suction. This intake of water results from the suction pump 70 pulling water through a check valve 78 attached to an end of the rib 22 in the body of water 14. The check valve 78 allows water to be pulled into the rib 22 from the water 14 but prevents water from discharging from the rib 22 into the body of water 14 as will allow that water to be used to inflate the rib 22 as will be described.

Water drawn through the rib valve 76 is discharged by the suction pump 70 to a discharge port 80 where it is fully or partially blocked from the exit port 81 by a main discharge valve 82 and thus diverted through a secondary passage 84 past inflation valve 86 into a water accumulator 88. The water accumulator 88 may provide, for example, a bladder within a rigid container, the bladder inflating against trapped air pressure.

Once a suitable pressure of water is obtained in the accumulator 88, the suction pump 70 may be stopped or vented and valve 82 opened, valve 86 closed, valve 76 closed, and a valve 90 communicating from the accumulator 88 to the rib 22 opened to allow pressurized water to flow into the rib 22. This pressurized water inflates the rib 22 opening the conduit 20 of the hose 16.

The valve 74 may then be opened, valve 82 opened, and water pumped through the conduit to the discharge port 80 and out an exit port 81 for use in irrigation or the like.

At the conclusion of the pumping, valve 90 may be closed, valve 74 may be partially closed and valve 76 may be opened to deflate the conduit 20 and stiffening ribs 22 using the suction of the suction pump 70 allowing the hose 16 to be rolled for compact storage in its original configuration.

It is specifically intended that the present invention not be limited to the embodiments and illustrations contained herein, but include modified forms of those embodiments including portions of the embodiments and combinations of elements of different embodiments as come within the scope of the following claims.

We claim:

1. A method of pumping water from a surface of a body of water comprising the steps of:
(a) positioning a portable suction pump adjacent to the body of water;
(b) connecting a collapsible suction pipe to the suction pump, the collapsible pipe providing a water resistant tubular body extending from the suction pump to the body of water, the conduit flexibly opening to provide a channel for passage of liquid water and collapsing for storage;
(c) inflating at least one stiffening rib attached to the tubular body to hold the conduit open; and
(d) pulling water by suction of the suction pump through the conduit while maintaining inflation of the stiffening rib.

2. The method of claim 1 further including the step of deflating the stiffening rib and flattening the tubular body in a direction perpendicular to its length to roll the suction pipe about an axis.

3. The method of claim 1 wherein the step (c) inflates the stiffening rib with water from the body of water.

4. The method of claim 1 wherein step (b) includes the step of extending the collapsible pipe in collapsed form to place an end of the stiffening rib in the body of water and wherein step (c) inflates the stiffening rib by drawing water through the stiffening rib to be used in that inflation.

5. The method of claim 1 wherein an end of the stiffening rib that may be placed in the body of water includes a check valve and including the steps of drawing water through the stiffening rib in a first direction and then reversing the flow of water in the stiffening rib to inflate the stiffening rib.

6. The method of claim 1 wherein step (c) inflates at least one stiffening rib attached to the tubular body to extend the conduit.

7. The method of claim 1 further including the step of assembling the collapsible suction pipe from multiple collapsible suction pipe sections using couplings that join tubular bodies of the sections and inflatable stiffening rib of the section.
